(19) United States
(12) Patent Application Publication
(10) Pub. No.: US 2013/0020742 A1
(43) Pub. Date: Jan. 24, 2013

(54) BLOW MOULDING MACHINE AND METHOD OF BLOW MOULDING

(71) Applicant: Stephen Barter, Hornsby (AU)

(72) Inventor: Stephen Barter, Hornsby (AU)

(73) Assignee: PRO TECHNICAL PLASTIC MANUFACTURING SOLUTIONS PTY LTD, Hornsby (AU)

(21) Appl. No.: 13/638,077

(22) PCT Filed: Apr. 12, 2011
(86) PCT No.: PCT/AU2011/000417

§ 371 Date: Sep. 28, 2012

(30) Foreign Application Priority Data
Apr. 12, 2010 (AU) 2010901538

(51) Int. Cl. B29C 49/04

(52) U.S. Cl. 264/500; 425/522

(57) ABSTRACT

A blow moulding machine is disclosed including at least one extrusion head for forming parisons; a mould for forming articles from the parisons, the mould including at least one mould cavity, an arrangement of blow pins for blowing the parisons in the mould to form articles; and wherein the mould is moveable with respect to the arrangement of blow pins and wherein two blow pins are provided for each mould cavity.

### TECHNICAL FIELD

The present invention relates to a blow moulding machine and method of blow moulding. The invention particularly relates to blow moulding of plastic bottles.

### BACKGROUND TO THE INVENTION

It is known to form plastic containers by blow moulding. Typically, tubular parisons are formed by an extruder head, these parisons are then blown in a mould to form containers. The containers can be used to hold a wide variety of products including cosmetics, cleaning products, chemicals, foods and drinks

Industrial blow moulding machines can usually be configured to allow production of a wide range of articles. This is achieved by changing the mould used in the machine, and also by changing the type of plastic being used in the machine. A mould may include one or more cavities that define the outer dimensions of an article being blown in the mould. For moulds with a number of cavities, the cavities are usually identical. Multiple cavities are employed to increase the rate of production of articles by a particular machine.

The costs involved in operating a blow moulding machine include the cost of the machine, the cost of moulds, along with costs for raw materials, energy, premises and labour.

There is a continued need to improve the efficiency of blow moulding operations.

### SUMMARY OF THE INVENTION

In a first aspect the present invention provides a blow moulding machine including at least one extrusion head for forming parisons; a mould for forming articles from the parisons, the mould including at least one mould cavity, an arrangement of blow pins for blowing the parisons in the mould to form articles; and wherein the mould is moveable with respect to the arrangement of blow pins and wherein two blow pins are provided for each mould cavity.

The blow pins may be provided on a shuttle which reciprocates with respect to the at least one extrusion head.

A first actuator may effect movement between a fixed part of the machine and the shuttle, and a second actuator may effect movement between the shuttle and the mould.

The extrusion heads may be disposed above the mould and the blow pins may be disposed b beneath the mould.

The blow pins may be mounted on a removable manifold.

In a second aspect the present invention provides a method of forming articles by blow moulding including the steps of: a) forming a first parison with an extrusion head; b) blowing the first parison with a first blow pin to form a first article in a mould cavity; c) at least partially forming a second parison by way of the extrusion head; d) separating the mould cavity from the first article; e) surrounding the second parison with the mould cavity; and f) blowing the second parison with a second blowpin to form a second article in the mould cavity.

In a third aspect the present invention provides a sub-assembly for use in association with a blow moulding machine including: a body which is arranged to be mounted to a blow moulding machine; a shuttle which is provided with at least two blowpins; the shuttle is moveably mounted to the body to allow the shuttle to reciprocate between first and second positions with respect to the body.

### BRIEF DESCRIPTION OF THE DRAWINGS

An embodiment of the present invention will now be described, by way of example only, with reference to the accompanying drawings, in which:

FIGS. 1 to 4 are schematic illustrations showing a blow moulding apparatus and the sequence of operations to produce an article by blow moulding according to an embodiment of the invention;

FIG. 5 is an end view of a blow moulding machine according to an embodiment of the invention;

FIGS. 6 to 9 illustrate the sequence of FIGS. 1 to 4 using the blow moulding apparatus of FIG. 5 with a four cavity mould; and

FIG. 10 is a side view of a further alternative embodiment of the invention.

### DETAILED DESCRIPTION OF THE PREFERRED EMBODIMENT

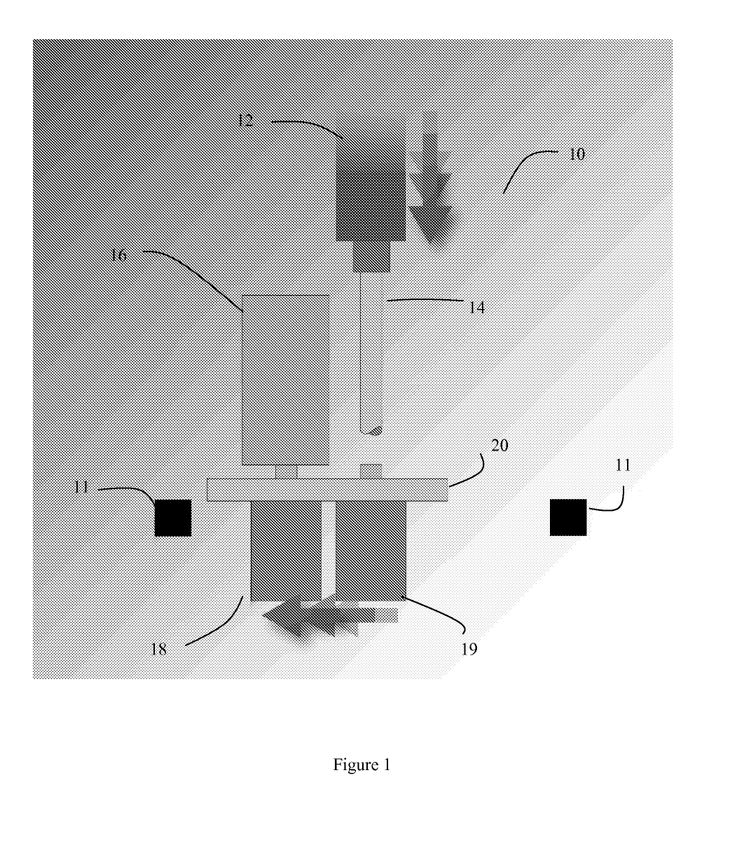

Referring to FIG. 1, a blow moulding machine 10 is shown including a nodding extrusion head 12 for forming tubular parisons 14, and two blow pins 18, 19. The blow pins are mounted on a shuttle 20 which can move between two positions as will be described. A mould 16 having a single mould cavity is shown which is able to move in relation to shuttle 20 between two positions aligned with either of blow pins 18, 19. The frame of the machine is indicated by rails 11. It is to be noted that there are twice as many blow pins as there are mould cavities.

The sequence of operations for forming an article by way of machine 10 will now be described with reference to FIGS. 1 to 4. The guide rails 11 remain stationary throughout the sequence. The extrusion head carries out a nodding movement up and down during the sequence, but does not move from side to side.

In FIG. 1, the mould 16 is aligned with blowpin 18 and contains a parison (not visible) which is being blown to form an article. Simultaneously to blowing the parison in the mould 16, another parison 14 is being formed by way of extrusion head 12. The shuttle is in its first position, to the left side of machine 10.

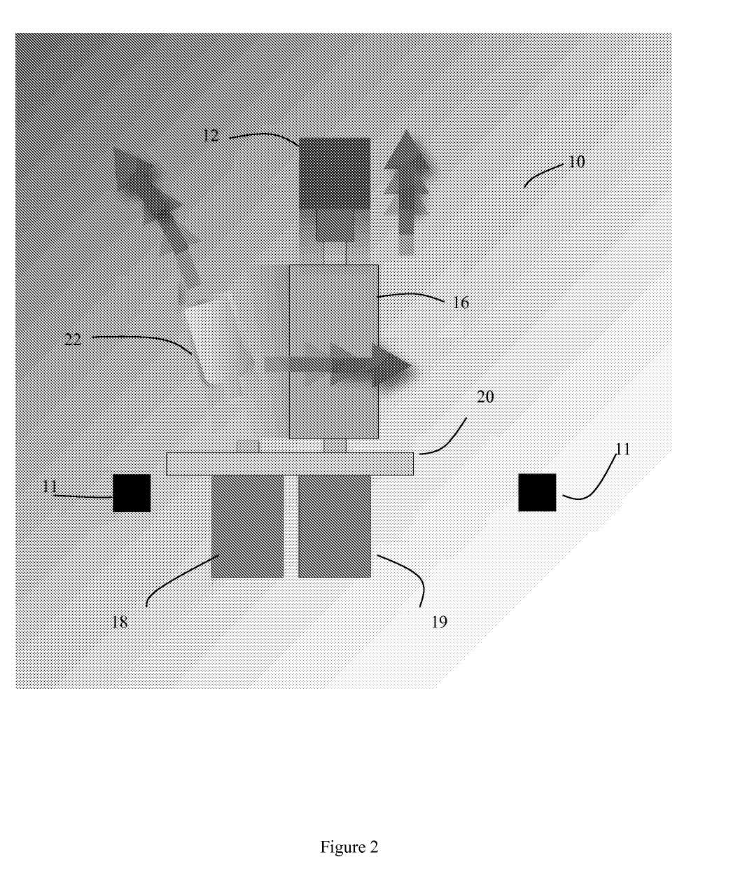

In FIG. 2, mould 16 has opened to reveal a finished article being bottle 22. Mould 16 moves with respect to shuttle 20 to align with blow pin 19. Bottle 22 is ejected from blow pin 18. The mould cavity has surrounded the parison 14 that was visible in FIG. 1. The parison in mould 16 begins to be blown. The parison 14 is cut from head 12 which nods upwards.

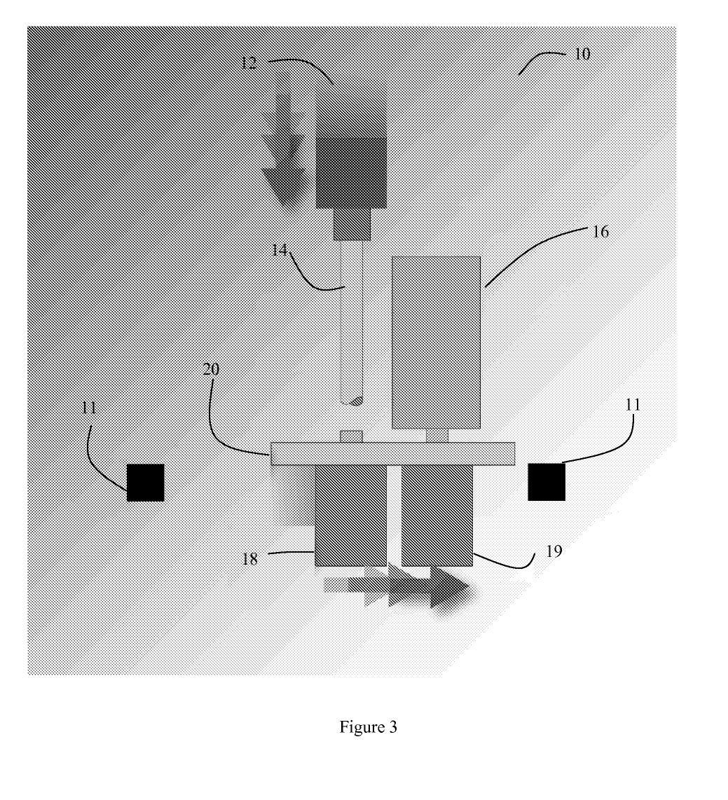

Referring to FIG. 3, shuttle 20 has moved to its second position along with mould 16, to the right hand side of machine 10. The parison continues to be blown in mould 16. Simultaneously to this, a second parison 14 is being formed from the extrusion head 12.

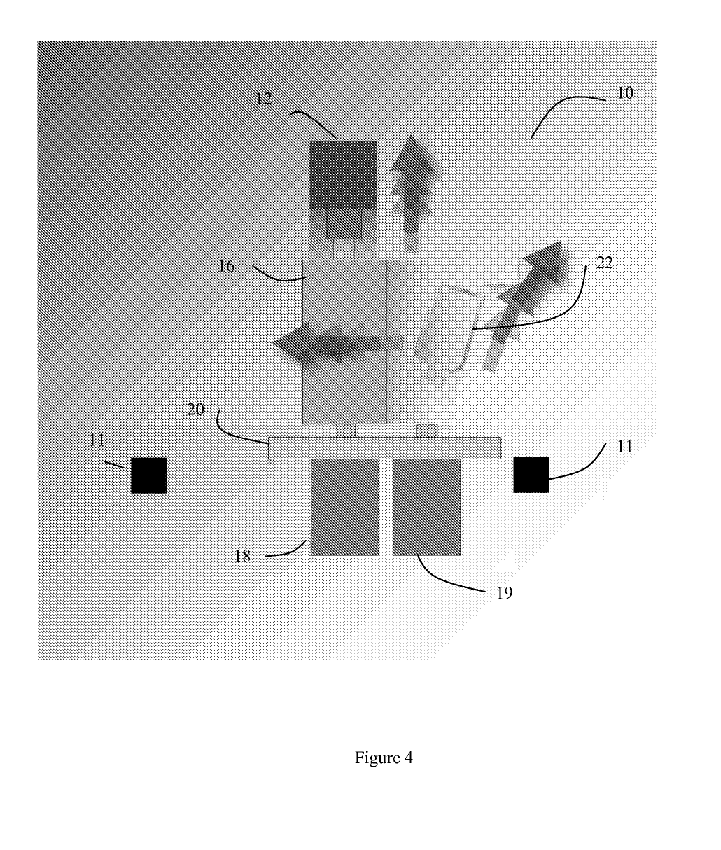

Referring to FIG. 4, mould 16 has opened to reveal a second bottle 22. Mould 16 moves in relation to the shuttle to align with blowpin 18 and has surrounded the parison that was shown forming in FIG. 3. Blowing of parison in mould 20 commences. The second bottle 22 is ejected from blowpin 17. Shuttle next moves back to its first position, which is as seen in FIG. 1 and the sequence repeats indefinitely producing two bottles during each sequence

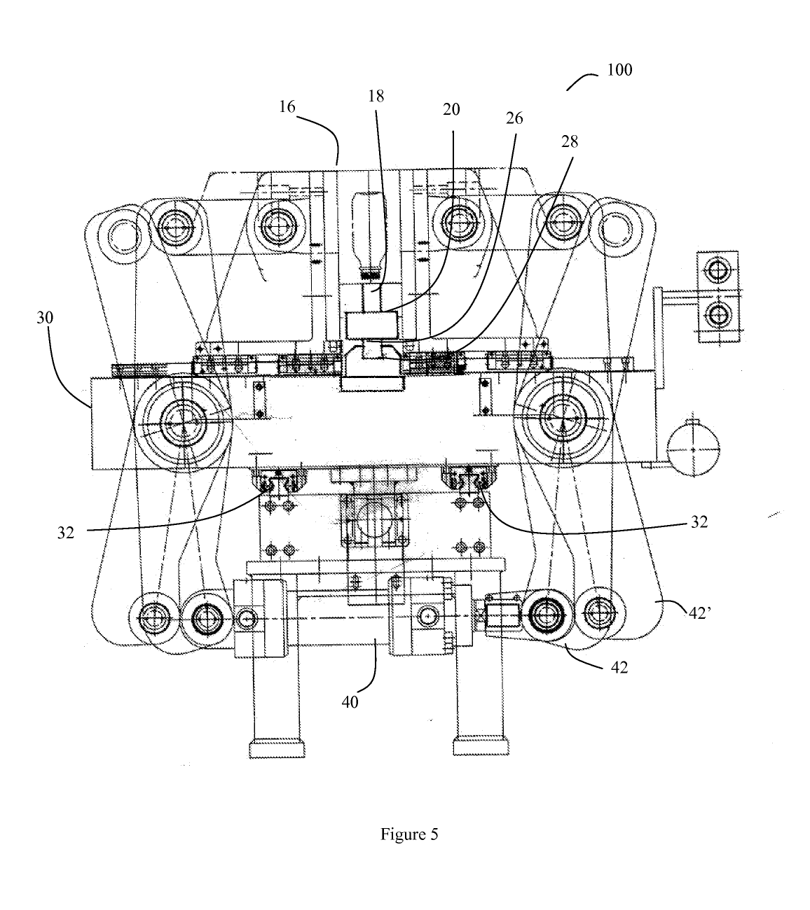

The arrangement can be scaled up by multiplying the number of extrusion heads, mould cavities and blow pins. Referring to FIGS. 5 to 8, the sequence of FIGS. 1 to 4 is illustrated in relation to a machine configured with a four cavity mould. Like reference numerals have been used to indicate components corresponding to the schematic illustrations of FIGS. 1 to 4.

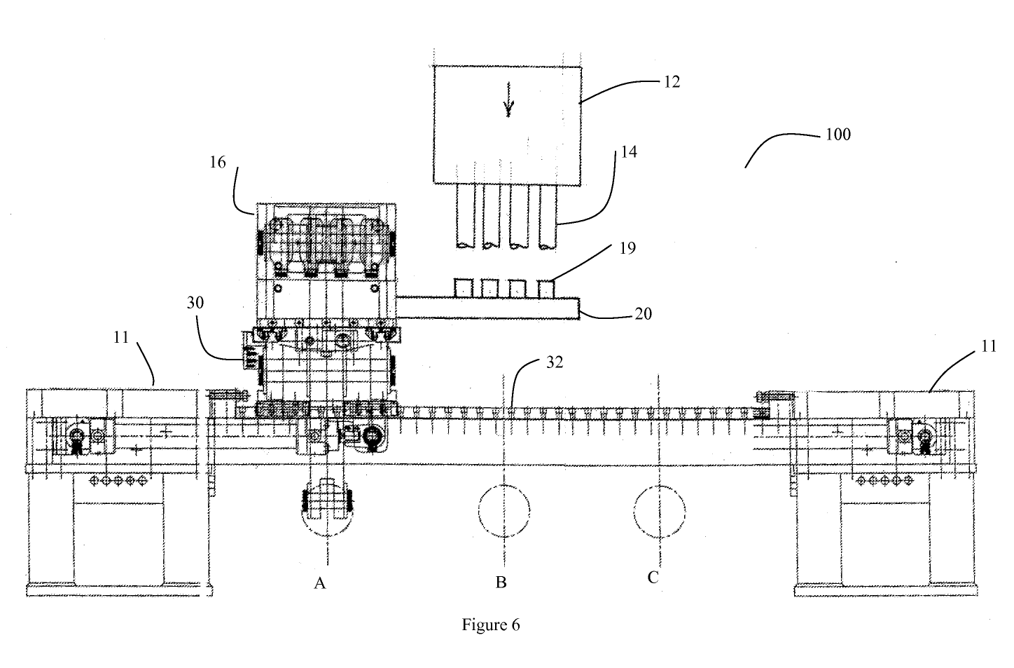

Referring to FIGS. 5 and 6, a blow moulding machine 100 is shown. This machine is based on a 780D model of blow moulding machine produced by Sabman, Thailand. The machine includes a body in the form of carriage 30 which carries the components for opening and closing the mould 16 in the form of pivot arms 42 which are operated by hydraulic ram 40. Arms 42 are shown in the mould open position, the same arms 42′ are shown in ghost outline in the mould closed position. Carriage slides along guide rails 32 and is movable between positions A, B and C.

In order to implement the present invention, the carriage 30 has been modified to include a shuttle 20, which includes a bearing rail 26 that is a smooth sliding fit with bearing block 28. A first hydraulic ram is mounted between the shuttle 20 and the fixed frame of the machine and effects reciprocal movement of the shuttle with respect to the machine frame. A second hydraulic ram is mounted between the shuttle and carriage 30 effects movement of the carriage 30 with respect to shuttle 20. The positions of shuttle 20 and carriage 30 are controlled by operation of these two rams.

Machine 100 has been configured to include an arrangement of four nodding extrusion heads 12, which in use continually extrude four parisons 14. A four-cavity mould 16 has been mounted upon carriage 30. A set of four blow pins 19 are shown, another set of four blow pins 18 is obscured by the mould 16 in FIG. 6.

The sequence of operations carried out by the machine will now be described with reference to FIGS. 6 to 9.

In FIG. 6 the positions of components of the machine 100 correspond to the positions shown in FIG. 1. The mould 16 is aligned with blowpins 18 and contains four parisons (not visible) which are being blown to form articles. Simultaneously to blowing the parisons in the mould 16, another set of four parisons 14 is being formed by way of extrusion head 12. The shuttle 20 is in its first position, to the left side of machine 100.

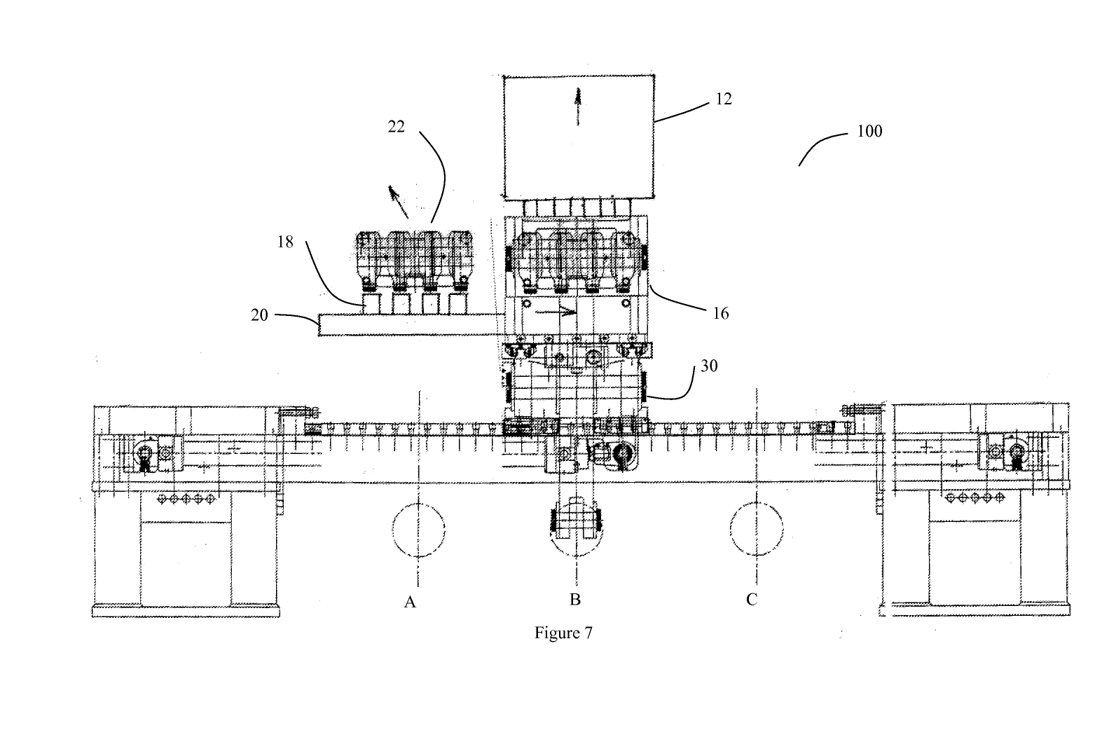

Referring to FIG. 7, the positions of components of the machine 100 correspond to the positions shown in FIG. 2. Mould 16 has opened to reveal a finished set of four bottles 22. The second hydraulic ram has operated to move carriage with respect to the shuttle to move carriage to position C to align with blow pins 19. Shuttle 20 has remained stationary. Bottles 22 are ejected from blow pins 18. The mould cavities have surrounded the four parisons 14 that were visible in FIG. 5. The parisons in mould 16 begin to be blown. The parisons 14 are cut from head 12 which nods upwards.

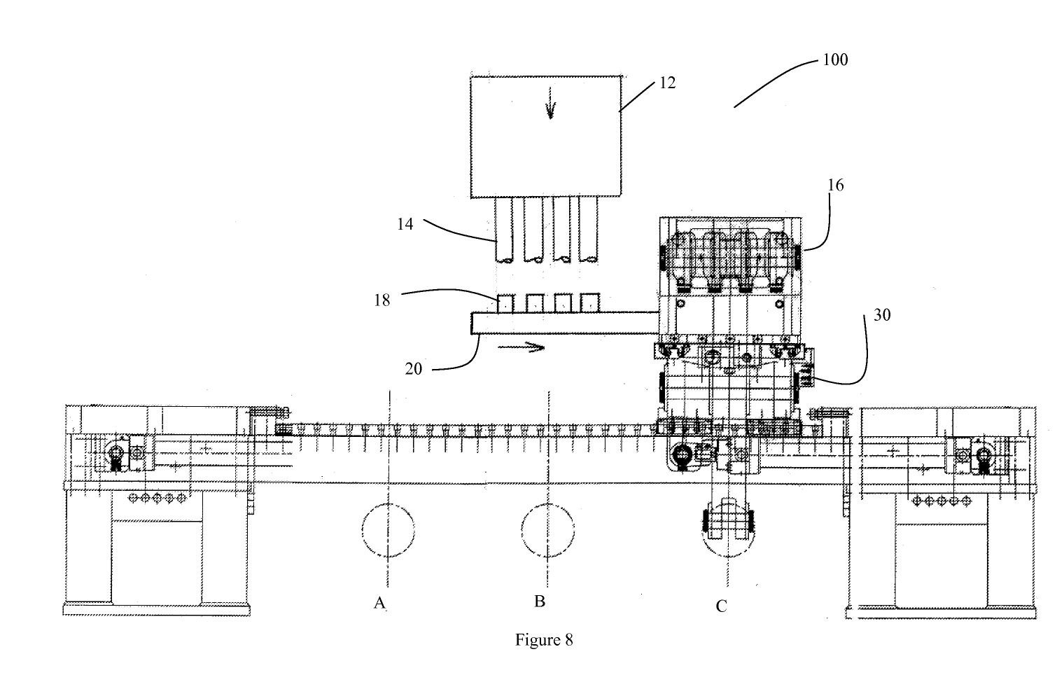

Referring to FIG. 8, the positions of components of the machine 100 correspond to the positions shown in FIG. 3. The first hydraulic ram has operated to move both of shuttle 20 and carriage 30 together. Carriage 30 has moved to position C, and the shuttle 20 has moved to its second position, to the right hand side of machine 10. The parisons continue to be blown in mould 16. Simultaneously to this, a second set of parisons 14 is being formed from the extrusion heads 12.

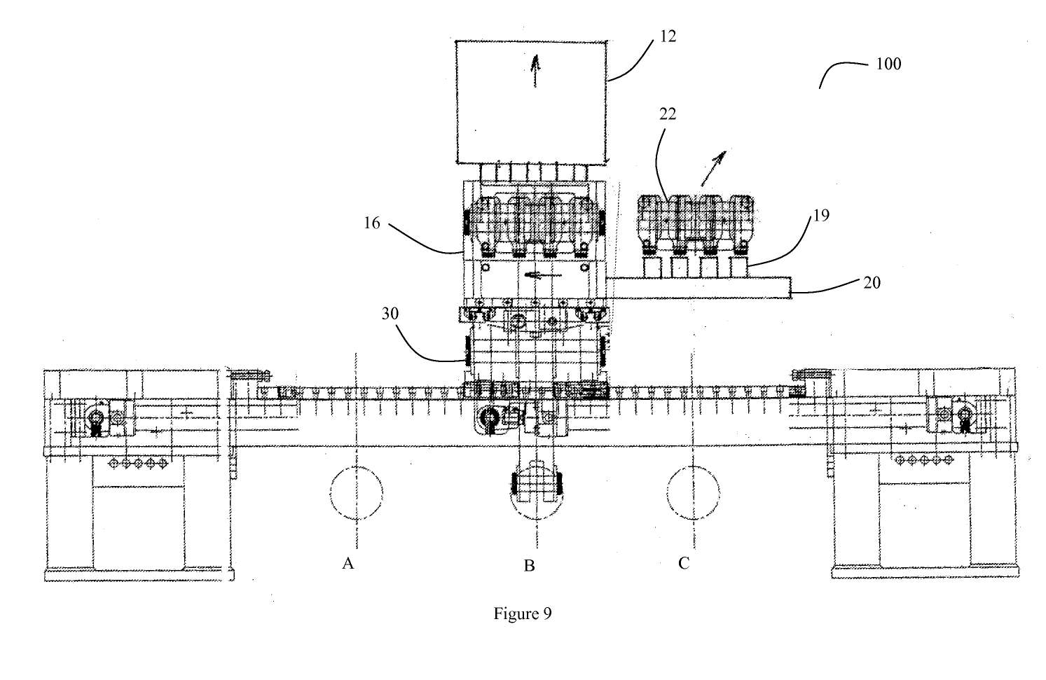

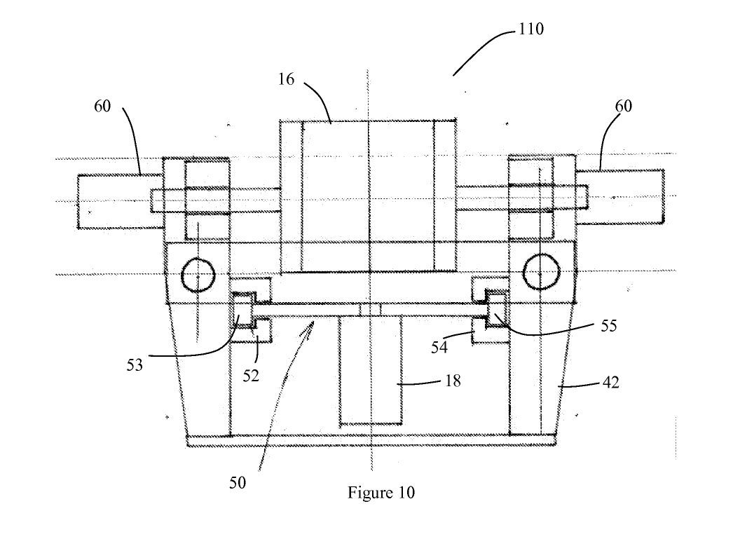

Referring to FIG. 9, the positions of components of the machine 100 correspond to the positions shown in FIG. 4. Mould 16 has opened to reveal a second set of bottles 22. The first hydraulic ram has operated to move carriage 30 to position B to align mould 16 with the extrusion heads 12. During the movement of carriage 30, shuttle remains stationary and thus remains in its second position, to the right side of the machine. Mould 16 has surrounded the parisons that were shown forming in FIG. 8. Blowing of parisons in mould 16 commences. The second set of bottles 22 is ejected from blowpins 19. Shuttle 20 and carriage 30 move together back to their starting positions, which are as seen in FIG. 6 and the sequence repeats indefinitely producing two sets of four bottles during each sequence.

Referring to FIG. 11, an alternative embodiment of machine is shown. This arrangement is used if the blowpins 18, 19 are required to be moving blowpins which require additional clearance. In this embodiment, a modified shuttle 50 is employed underneath which the moveable blowpins 18,19 are mounted. Opposite edges 53, 55 of the shuttle 50 slide in channels 52, 54. When ram 40 (not shown) operates to spread about pivot arms 42, the shuttle resist the pivot points of the arms from moving away from one another. The pivot arms have been removed and the mould 16 is operated directly by two hydraulic rams 60.

By way of the invention, efficiency of the machine is increased by reducing the idle time of the mould.

In the embodiment described in FIGS. 5 to 9, sets of four blowpins were used. In other embodiments, different numbers of blowpins can be used. The sets of blowpins may be provided as a removable manifold, thus improving the ease with which the machine can be reconfigured for different production runs requiring different numbers of blowpins.

In the embodiment described above the parisons were continuously extruded from the extrusion head. In other embodiments, the extrusion can be stopped and restarted between the formation of each parison.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A blow moulding machine comprising:
at least one extrusion head for forming parisons;
a mould for forming articles from the parisons, the mould comprising at least one mould cavity,
an arrangement of blow pins for blowing the parisons in the mould to form articles; and
wherein the mould is moveable with respect to the arrangement of blow pins and wherein two blow pins are provided for each mould cavity.

2. A blow moulding machine according to claim 1 wherein the blow pins are provided on a shuttle which reciprocates with respect to the at least one extrusion head.

3. A blow moulding machine according to claim 2 wherein a first actuator effects movement between a fixed part of the machine and the shuttle, and a second actuator effects movement between the shuttle and the mould.

4. A blow moulding machine according to claim 1, wherein the at least one extrusion head is disposed above the mould and the blow pins are disposed beneath the mould.

5. A blow moulding machine according to claim 1, wherein the blow pins are mounted on a removable manifold.

6. A method of forming articles by blow moulding comprising the steps of:
forming a first parison with an extrusion head;
blowing the first parison with a first blow pin to form a first article in a mould cavity;
at least partially forming a second parison by way of the extrusion head;
separating the mould cavity from the first article;
surrounding the second parison with the mould cavity; and
blowing the second parison with a second blowpin to form a second article in the mould cavity.

7. A sub-assembly for use in association with a blow moulding machine comprising:
a body which is arranged to be mounted to a blow moulding machine;
a shuttle which is provided with at least two blowpins;
the shuttle is moveably mounted to the body to allow the shuttle to reciprocate between first and second positions with respect to the body.
